(19) United States
(12) Patent Application Publication
(10) Pub. No.: US 2026/0149250 A1
(43) Pub. Date: May 28, 2026

(54) CLAMP AND WIRE HARNESS

(71) Applicant: SUMITOMO WIRING SYSTEMS, LTD., Yokkaichi-shi, Mie (JP)

(72) Inventors: Hiroki YAMANOUCHI, Yokkaichi-shi (JP); Katsutoshi IZAWA, Yokkaichi-shi (JP)

(73) Assignee: SUMITOMO WIRING SYSTEMS, LTD., Yokkaichi-shi, Mie (JP)

(21) Appl. No.: 19/150,054

(22) PCT Filed: Jan. 16, 2024
(86) PCT No.: PCT/JP2024/000884

§ 371 Date: Jul. 22, 2025

(30) Foreign Application Priority Data
Feb. 3, 2023 (JP) 2023-015316

(51) Int. Cl. H02G 3/32; B60R 16/02

(52) U.S. Cl. CPC H02G 3/32; B60R 16/0215

(57) ABSTRACT

A clamp that includes: a first tube configured to hold a wire; a second tube disposed spaced apart from the first tube and covering an outer circumference of the first tube; a fixing member provided on the second tube and configured to fix the second tube to a vehicle; and a support provided between the first tube and the second tube, and supporting the first tube on the second tube, wherein the support displaceably supports the first tube such that an axis of the first tube inclines with respect to an axis of the second tube.

### BACKGROUND

The present disclosure relates to a clamp and a wire harness. JP 2015-53804A discloses a wire harness that includes a wire and a clamp that fixes the wire to a vehicle. The clamp includes a tubular member that holds the wire and a fixing member that fixes the tubular member to the vehicle.

### SUMMARY

When the wire member extending outward from the tubular member of the clamp as described above oscillates, for example, a load may be applied to the wire member due to the tubular member. It is desired to suitably hold the wire member by reducing such a load applied to the wire member due to the tubular member of the clamp.

An exemplary aspect of the disclosure provides a clamp and a wire harness with which a wire member can be suitably held.

A clamp according to the present disclosure includes: a first tubular member configured to hold a wire member including a wire; a second tubular member disposed spaced apart from the first tubular member and covering an outer circumference of the first tubular member; a fixing member provided on the second tubular member and configured to fix the second tubular member to a vehicle; and a support member provided between the first tubular member and the second tubular member, and supporting the first tubular member on the second tubular member, and the support member displaceably supports the first tubular member such that an axis of the first tubular member inclines with respect to an axis of the second tubular member.

The clamp and the wire harness according to the present disclosure exhibit an effect of making it possible for a wire member to be suitably held.

### BRIEF DESCRIPTION OF THE DRAWINGS

FIG. 1 is a schematic plan view showing an example of a state where a wire harness is used.

FIG. 2 is a perspective view of a wire harness according to an embodiment.

FIG. 3 is a cross-sectional view taken along line 3-3 in FIG. 2.

FIG. 4 is a cross-sectional view taken along line 4-4 in FIG. 2.

FIG. 5 is a schematic view illustrating operations of a clamp.

FIG. 6 is a schematic view illustrating operations of the clamp.

FIG. 7 is a cross-sectional view showing a wire harness according to a first variation.

FIG. 8 is a cross sectional view showing a wire harness according to a second variation.

### DETAILED DESCRIPTION OF EMBODIMENTS

### Description of Embodiments of the Present Disclosure

First, embodiments of the present disclosure will be listed and described.
[1] A clamp according to the present disclosure is a clamp including: a first tubular member configured to hold a wire member including a wire; a second tubular member disposed spaced apart from the first tubular member and covering an outer circumference of the first tubular member; a fixing member provided on the second tubular member and configured to fix the second tubular member to a vehicle; and a support member provided between the first tubular member and the second tubular member, and supporting the first tubular member on the second tubular member, and the support member displaceably supports the first tubular member such that an axis of the first tubular member inclines with respect to an axis of the second tubular member.

According to this configuration, when the wire member extending outward of the first tubular member oscillates, the first tubular member is displaced to follow the wire member. This makes it possible to reduce a load applied on the wire member due to the first tubular member.
[2] In the configuration of [1] above, a configuration is also possible in which the second tubular member has a second outer circumferential wall and a second inner circumferential wall disposed between the second outer circumferential wall and the first tubular member, the fixing member is connected to the second outer circumferential wall, the support member is connected to the second inner circumferential wall, and the first tubular member, the support member, and the second inner circumferential wall are made of a material more elastically deformable than the second outer circumferential wall and the fixing member. According to this configuration, for example, the elastic deformation of the first tubular member, the support member, and the second inner circumferential wall can improve the followability of the first tubular member to the oscillation of the wire member. Accordingly, it is possible to reduce the load applied on the wire member due to the first tubular member.
[3] In the configuration of [2] above, it is also possible that the first tubular member, the support member, and the second inner circumferential wall are made of a rubber-based material, and the second outer circumferential wall and the fixing member are made of a resin-based material.

As described above, since the first tubular member, support member, and second inner circumferential wall are made of a rubber-based material, for example, vibration of the wire member is likely to be absorbed. Also, for example, the oscillation of the wire member is more likely to be damped. As described above, since the second outer circumferential wall and the fixing member are made of a resin-based material, for example, the strength of the second outer circumferential wall and the fixing member can be easily secured.
[4] In the configuration of [3] above, it is also possible that the first tubular member, the support member, and the second inner circumferential wall are an integrally molded article made of a rubber-based material. According to this configuration, for example, an adhesive layer that adheres the support member to the first tubular member and the second inner circumferential wall can be omitted. Accordingly, the clamp can be easily manufactured.
[5] In any one of configurations of [2] to [4] above, it is also possible that the second outer circumferential wall and the second inner circumferential wall are assembled in an engaged relationship. According to this configuration, for example, relative positional misalignment between the second outer circumferential wall and the second inner circumferential wall can be easily suppressed.
[6] In any one of configurations of [1] to [5] above, a configuration is also possible where the first tubular member has a first opening end and a second opening end that are opposite opening ends in an axial direction of the first tubular member, and the support member is located on a center side relative to the first opening end and the second opening end.

According to this configuration, both the first and second opening end sides of the first tubular member can be easily displaced. This makes it possible to reduce the load on the wire member with respect also to the oscillation of both the first extending portion, which is a portion extending outward from the first opening end, and the second extending portion, which is a portion extending outward from the second opening end.
[7] In the configuration of [6] above, it is also possible that the support member is disposed at a position close to one of the first open end and the second opening end. According to this configuration, it is possible to easily displace either the first opening end side or the second opening end side in the first tubular member. Thus, for example, if the oscillation of either the first or second extending portion is relatively large, the load due to the oscillation can be suitably reduced. Therefore, it is possible to provide a clamp that addresses the oscillating behavior of the wire member.
[8] In any one of the configurations of [1] to [7] above, it is also possible that the support member has an annular shape along the circumferential direction of the first tubular member and the second tubular member. This configuration makes it possible to easily ensure the strength of the support member. For example, the first tubular member can easily ensure the strength of the support member with respect also to oscillation of the wire member along any direction.
[9] A wire harness according to the present disclosure includes the clamp according to claim 1, and the wire member held by the first tubular member of the clamp. According to this configuration, the same operations and effect as the clamp described above can be obtained.

### Detailed Description of Embodiments of Present Disclosure

A specific example of a clamp and a wire harness of the present disclosure will be described below with reference to the drawings. In the drawings, the configurations may be partially exaggerated or simplified for convenience in the description. Also, the dimensional ratios of various portions may differ among the drawings.

The term “tubular” as used in the description herein includes not only members with a continuous circumferential wall over the entire circumferential direction, but also members that have a tubular shape by combining multiple parts, and members that have a cutout or the like in part of the circumferential direction, such as a C-shape. The term “tubular” includes a shape having a cross section that has a circular, oval, or polygonal shape with sharp or rounded corners. The term “annular” as used in the description herein may also refer to any structure that forms a loop, a continuous shape without ends, or a generally loop-shaped structure with a gap, such as a C-shape. The “annular” shape includes, but is not limited to, circular, oval, and polygonal shapes with sharp or rounded corners.

### Overall Configuration of Wire Harness 10

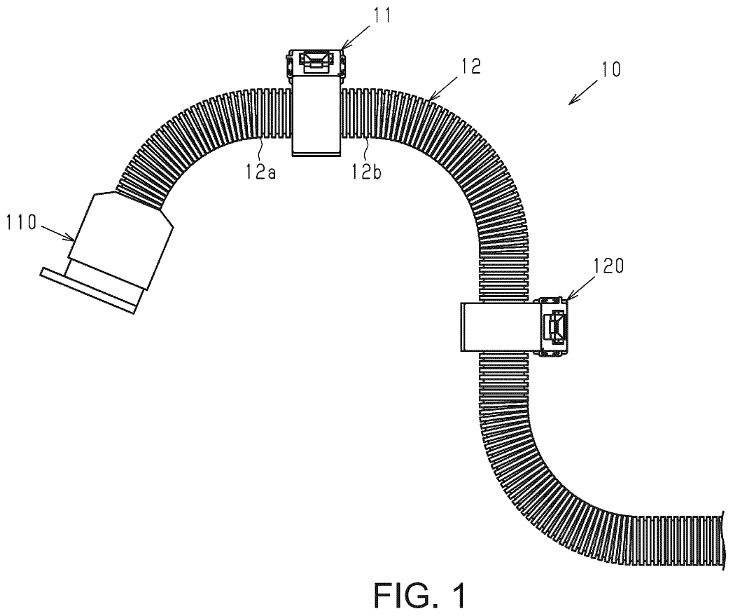

As shown in FIG. 1, a wire harness 10 has a clamp 11 and a wire member 12 held by the clamp 11. The wire harness 10 includes, for example, a first fixing portion 110 and a second fixing portion 120. The clamp 11 holds the wire member 12 that is routed between the first fixing portion 110 and the second fixing portion 120. The first fixing portion 110 is fixed to a first vibration source such as an engine, for example. The second fixing portion 120 is fixed to a second vibration source such as a vehicle body, for example.

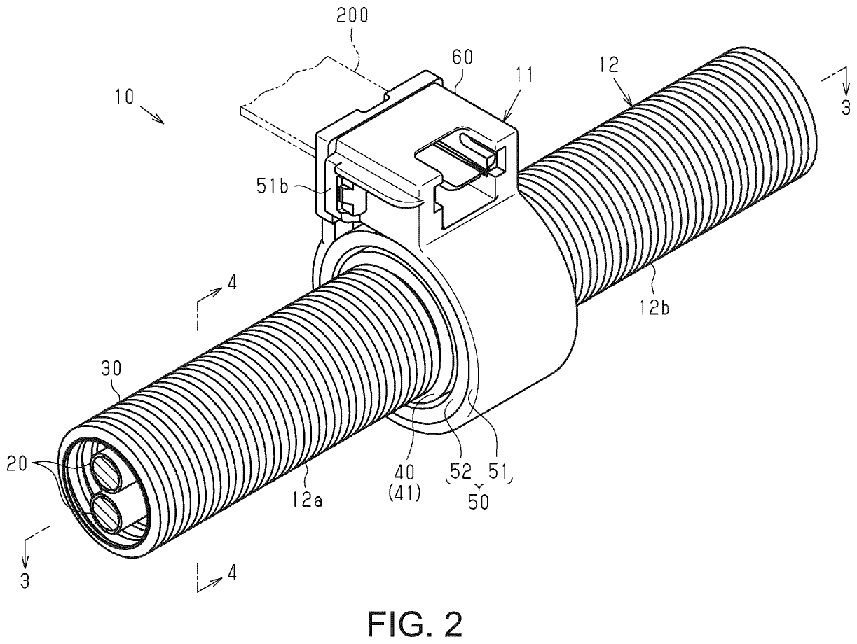

As shown in FIGS. 2 to 4, the clamp 11 has a first tubular member 40 (first tube), a second tubular member 50 (second tube), a fixing member 60, and a support member 70 (support).

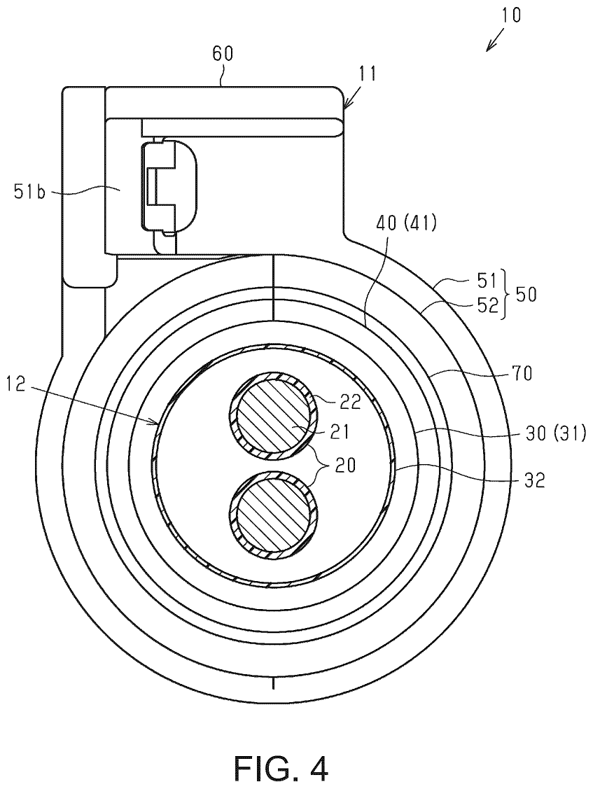

As shown in FIGS. 2 and 4, the wire member 12 has, for example, a plurality of wires 20 and an exterior member 30 that collectively surrounds the plurality of wires 20.

The wires 20 each include a coated wire having a conductive core wire 21 and an insulating coating 22 that surrounds the outer circumference of the core wire 21 and has insulating properties. Examples for a material for the insulating coating 22 include a resin material. Examples for materials for the core wire 21 include a metal material such as a copper-based or aluminum-based metal material.

The exterior member 30 has a tubular shape such as a cylindrical shape. The wires 20 are inserted into the exterior member 30. The exterior member 30, for example, has a function of protecting the wires 20 from flying debris and water droplets. The exterior member 30, for example, is flexible and easily bendable. Examples of the flexible exterior member 30 include a resin corrugated tube and a rubber waterproof cover.

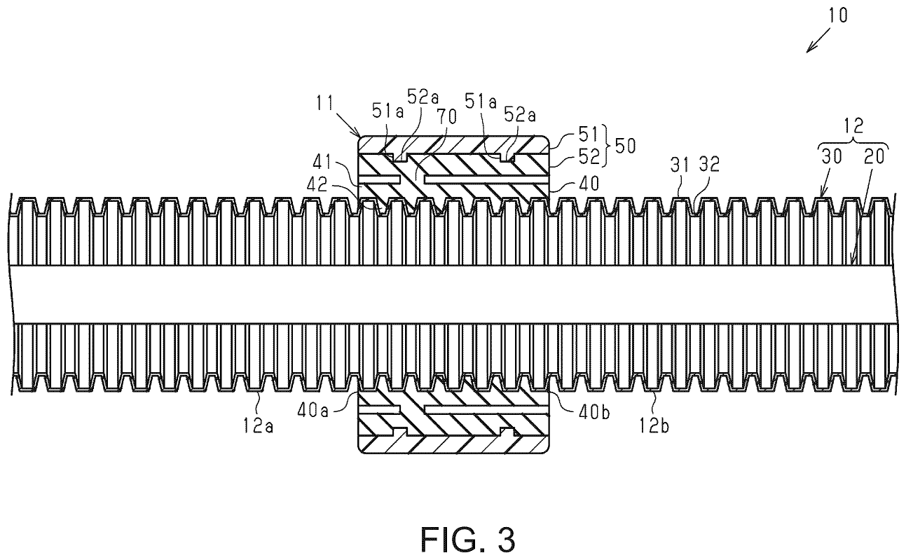

The exterior member 30 is, for example, a corrugated tube having a bellows shape and made of resin. Specifically, as shown in FIG. 3, the corrugated tube has a bellows structure in which large-diameter portions 31 and small diameter portions 32, which have a smaller diameter than the large diameter portions 31, are arranged alternately in the length direction. Each of the large diameter portions 31 and the small diameter portions 32 has, for example, an annular shape with one circumference along the circumferential direction of the exterior member 30. Materials for the exterior member 30 include polyolefins such as polypropylene and polyethylene, and synthetic resins such as polyamide, polyester, and ABS resin.

Next, the details of the clamp 11 are described.

### Configuration of First Tubular Member 40

As shown in FIGS. 2 to 4, the first tubular member 40 of the clamp 11 holds the wire member 12. The first tubular member 40 has a first circumferential wall 41 along the outer circumference of the wire member 12. As shown in FIG. 3, the first tubular member 40 has, for example, first protruding portions 42 that fit into an outer circumferential surface of the corrugated tube that is the exterior member 30. Specifically, the outer circumferential surface of the corrugated tube has recessed portions each composed of two adjacent large diameter portions 31 and one small diameter portion 32 between the two large-diameter portions 31. The first protruding portions 42 of the first tubular member 40 protrude from an inner surface of the first circumferential wall 41. The first protruding portions 42 are fitted into the above recesses in the corrugated tube to suppress relative movement of the first tubular member 40 and the wire member 12 along the axial direction. A plurality of the first protruding portions 42 are provided, for example, along the axial direction of the first circumferential wall 41. The number of first protruding portions 42 is not limited to plural, and may be singular.

As shown in FIG. 3, the first tubular member 40 has a first opening end 40a and a second opening end 40b, which are the opposite axial opening ends of the first tubular member 40. The wire member 12 has a first extending portion 12a extending outward from the first opening end 40a of the first tubular member 40 and a second extending portion 12b extending outward from the second opening end 40b. As shown in FIG. 1, the first extending portion 12a is connected to the first fixing portion 110. The first extending portion 12a oscillates due to vibration transmitted from the first vibration source to which the first fixing portion 110 is fixed. The second extending portion 12b extends to the second fixing portion 120. The second extending portion 12b oscillates due to vibration transmitted from the second vibration source to which the second fixing portion 120 is fixed. In other words, in the wire harness 10, the first extending portion 12a and the second extending portion 12b are oscillating sections.

### Configuration of Second Tubular Member 50

As shown in FIGS. 2 to 4, the second tubular member 50 of the clamp 11 covers an outer circumference of the first tubular member 40. The second tubular member 50 is spaced apart from the first tubular member 40. The second tubular member 50 has, for example, a second outer circumferential wall 51 and a second inner circumferential wall 52. The fixing member 60 is connected to the second outer circumferential wall 51. The second inner circumferential wall 52 is disposed between the second outer circumferential wall 51 and the first tubular member 40.

As shown in FIG. 3, the second outer circumferential wall 51 and the second inner circumferential wall 52 can be assembled in an engaged relationship, for example. Specifically, the second outer circumferential wall 51 has, for example, second protruding portions 51a extending along the circumferential direction. The second inner circumferential wall 52 has, for example, second recessed portions 52a into which the second protruding portions 51a can fit. The second protruding portions 51a and the second recessed portions 52a, for example, have a shape that extends over the entire circumference of the second tubular member 50. The number of the second protruding portions 51a and the second recessed portions 52a may be singular or plural.

As shown in FIG. 4, the second outer circumferential wall 51 has a locking portion 51b that allows the opening and closing of a portion in the circumferential direction thereof. By releasing the locking portion 51b, the second outer circumferential wall 51 becomes an open state capable of being attached to the wire member 12. By locking the locking portion 51b, the second outer circumferential wall 51 can become a closed state.

### Configuration of Fixing Member 60

As shown in FIGS. 2 and 4, the fixing member 60 of the clamp 11 fixes the second tubular member 50 to the vehicle. The fixing member 60 is provided on the second tubular member 50. The fixing member 60 is connected to the second outer circumferential wall 51 of the second tubular member 50. The fixing member 60 is fixed to an attachment location 200 of the vehicle. The attachment location 200 is, for example, a bracket for an engine.

### Configuration of Support Member 70

As shown in FIGS. 3 and 4, the support member 70 of the clamp 11 supports the first tubular member 40 on the second tubular member 50. The support member 70 is provided between the first tubular member 40 and the second tubular member 50. The support member 70 displaceably supports the first tubular member 40 such that an axis of the first tubular member 40 inclines relative to an axis of the second tubular member 50.

The support member 70 is disposed, for example, on the center side of the first tubular member 40, relative to the first opening end 40a and the second opening end 40b. The support member 70 is disposed near the opening end that is one of the first opening end 40a and the second opening end 40b. The support member 70 is disposed closer to the first opening end 40a than to the second opening end 40b, for example. The support member 70 has an annular shape along the circumferential direction of the first tubular member 40 and the second tubular member 50.

### Material of Clamp 11

Examples of materials for the clamp 11 include resin-based materials and rubber-based materials. Examples of resin-based materials include polyolefin resins, polyamide resins, polyester resins, and ABS resins. Examples of rubber-based materials include a rubber such as EPDM (ethylene propylene diene rubber) and an elastomer such as olefin-based elastomer.

The first tubular member 40, the support member 70, and the second inner circumferential wall 52 of the second tubular member 50 are preferably constituted of a material that is more elastically deformable than the second outer circumferential wall 51 of the second tubular member 50 and the fixing member 60.

It is more preferable that the first tubular member 40, the support member 70, and the second inner circumferential wall 52 of the second tubular member 50 are made of a rubber-based material and the second outer circumferential wall 51 of the second tubular member 50 and the fixing member 60 are made of a resin based material. It is further preferable that the first tubular member 40, the support member 70, and the second inner circumferential wall 52 of the second tubular member 50 are each formed as an integrally molded product made of a rubber-based material. It is further preferable that the second outer circumferential wall 51 of the second tubular member 50 and the fixing member 60 are each formed as an integrally molded product made of a rubber-based material.

### Method of Manufacturing Wire Harness 10

An example of a manufacturing method for the wire harness 10 will be described. The manufacturing method for the wire harness 10 includes the process of attaching the clamp 11 to the wire member 12.

The first tubular member 40, the support member 70, and the second inner circumferential wall 52 can be attached to the second outer circumferential wall 51 in the open state. The first tubular member 40, the support member 70, and the second inner circumferential wall 52 of the clamp 11 have a dividing portion that allows opening and closing of a portion thereof in the circumferential direction. The dividing portion is provided along the entirety of the first tubular member 40, the support member 70, and the second inner circumferential wall 52 in the direction along the axis of the first tubular member 40. By opening the dividing portion, the wire member 12 can be disposed inside the first tubular member 40. Next, by closing the dividing section and closing the second outer circumferential wall 51 with the locking portion 51b, the clamp 11 can be attached to the wire member 12. The manufacturing method for the wire harness 10 includes a process of attaching the first fixing portion 110 and the second fixing portion 120 to the wire member 12, and the like.

The following describes operations of the present embodiment.

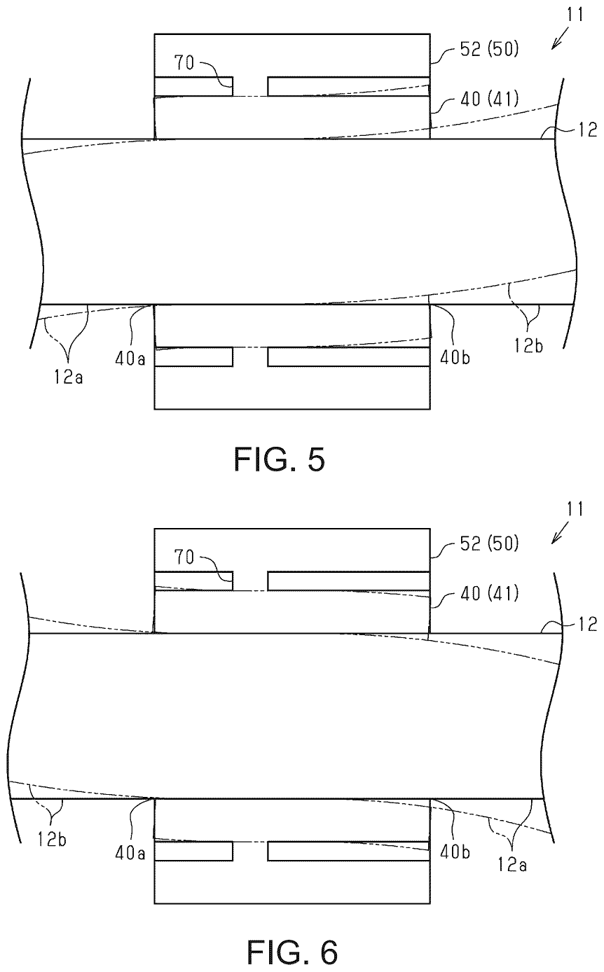

FIGS. 5 and 6 schematically show the first tubular member 40, the support member 70, and the second inner circumferential wall 52 of the second tubular member 50 shown in FIG. 3. The support member 70 of the clamp 11 displaceably supports the first tubular member 40 such that the axis of the first tubular member 40 inclines relative to the axis of the second tubular member 50. That is, the first opening end 40a side or the second opening end 40b side of the first tubular member 40 can be displaced so as to move to and away from the second tubular member 50, as shown by the two-dot chain lines in FIGS. 5 and 6.

As shown by the two-dot chain lines in FIGS. 5 and 6, for example, when the first extending portion 12a of the wire member 12 oscillates, the first opening end 40a side of the first tubular member 40 is displaced to follow the first extending portion 12a. For example, when the second extending portion 12b of the wire member 12 oscillates, the second opening end 40b side of the first tubular member 40 is displaced to follow the second extending portion 12b.

When the wire member 12 extending outward of the first tubular member 40 oscillates in this manner, the first tubular member 40 is displaced to follow the wire member 12. And thus, for example, it is unlikely that deformation under high load will occur to the extent that the wire member 12 bends due to being pressed down at the axial opening ends of the first tubular member 40.

Excessive displacement of the first tubular member 40 is restricted by the first tubular member 40 coming into contact with the second tubular member 50. This makes it possible to suppress excessive oscillation of the wire member 12.

The support member 70 is disposed, for example, on the center side relative to the first opening end 40a and the second opening end 40b. In this case, both the first opening end 40a side and the second opening end 40b side of the first tubular member 40 can be easily displaced as described above.

The support member 70 is disposed close to the opening end of one of the first opening end 40a and the second opening end 40b, for example. For example, the support member 70 is disposed closer to the first opening end 40a than to the second opening end 40b. In this case, in the first tubular member 40, the second opening end 40b side can be displaced more easily than the first opening end 40a side. For example, in the first tubular member 40, it is possible to increase the flexibility of the second opening end 40b side relative to that of the first opening end 40a side. For example, for this reason, if the oscillation of the second extending portion 12b is larger than that of the first extending portion 12a, it is possible to increase the followability of the second opening end 40b side of the second tubular member 50 to the oscillation of the second extending portion 12b.

The following describes effects of the present embodiment.
(1) The clamp 11 has the first tubular member 40 that holds the wire member 12 including the wires 20 and the second tubular member 50 that covers the outer circumference of the first tubular member 40. The clamp 11 has the fixing member 60 that fixes the second tubular member 50 to the vehicle, and the support member 70 that supports the first tubular member 40 on the second tubular member 50. The second tubular member 50 is spaced apart from the first tubular member 40. The fixing member 60 is provided on the second tubular member 50. The support member 70 is provided between the first tubular member 40 and the second tubular member 50. The support member 70 displaceably supports the first tubular member 40 such that the axis of the first tubular member 40 inclines relative to the axis of the second tubular member 50.

According to this configuration, as described above, it is possible to reduce the load applied on the wire member 12 due to the first tubular member 40. Therefore, it is possible to suitably hold the wire member 12.

Excessive displacement of the first tubular member 40 is limited by the first tubular member 40 coming into contact with the second tubular member 50. This makes it possible to suppress excessive oscillation of the wire member 12.
(2) The second tubular member 50 has the second outer circumferential wall 51 and the second inner circumferential wall 52 disposed between the second outer circumferential wall 51 and the first tubular member 40. The fixing member 60 is connected to the second outer circumferential wall 51. The support member 70 is connected to the second inner circumferential wall 52. It is preferable that the first tubular member 40, the support member 70, and the second inner circumferential wall 52 are made of a material that is more elastically deformable than the second outer circumferential wall 51 and the fixing member 60.

In this case, for example, the elastic deformation of the first tubular member 40, the support member 70, and the second inner circumferential wall 52 can improve the followability of the first tubular member 40 to the oscillation of the wire member 12. This makes it possible to further reduce the load applied on the wire member 12 due to the first tubular member 40. Thus, it is possible to hold the wire member 12 more suitably.
(3) The first tubular member 40, the support member 70, and the second inner circumferential wall 52 are made of a rubber-based material, which facilitates absorption of vibration of the wire member 12, for example. Also, for example, the oscillation of the wire member 12 is more easily damped. By forming the second outer circumferential wall 51 and the fixing member 60 using a resin-based material, for example, the strength of the second outer circumferential wall 51 and the fixing member 60 can be easily secured.
(4) When the first tubular member 40, the support member 70, and the second inner circumferential wall 52 are each formed as an integrally molded product made of a rubber-based material, for example, an adhesive layer that adheres the support member 70 to the first tubular member 40 and the second inner circumferential wall 52 can be omitted. Thus, the clamp 11 can be easily manufactured.
(5) The second outer circumferential wall 51 and the second inner circumferential wall 52 are assembled in an engaged relationship. This configuration makes it possible, for example, to easily suppress the relative positional misalignment of the second outer circumferential wall 51 and the second inner circumferential wall 52.
(6) The first tubular member 40 has the first opening end 40a and the second opening end 40b, which are opposite opening ends in the axial direction of the first tubular member 40. The support member 70 is disposed on the center side relative to the first and second opening ends 40a and 40b.

According to this configuration, both the first opening end 40a side and the second opening end 40b side of the first tubular member 40 can be easily displaced. Therefore, in the wire member 12, the load on the wire member 12 can be reduced with respect also to the oscillation of both the first extending portion 12a, which is a portion extending outward of the first opening end 40a, and the second extending portion 12b, which is a portion extending outward of the second opening end 40b. Thus, it is possible to hold the wire member 12 more suitably.
(7) It is preferable that the support member 70 is disposed close to the opening end of either the first opening end 40a or the second opening end 40b. According to this configuration, it is possible to easily displace either the first opening end 40a side or the second opening end 40b side in the first tubular member 40. Thus, for example, if the oscillation of either the first extending portion 12a or the second extending portion 12b is relatively large, the load due to the oscillation can be suitably reduced. Therefore, it is possible to provide a clamp 11 that addresses the oscillating behavior of the wire member 12.
(8) The support member 70 has an annular shape along the circumferential direction of the first tubular member 40 and the second tubular member 50. This configuration makes it easy to ensure the strength of the support member 70. For example, the first tubular member 40 makes it easier to ensure the strength of the support member 70 against oscillations along any direction of the wire member 12.

### Variations

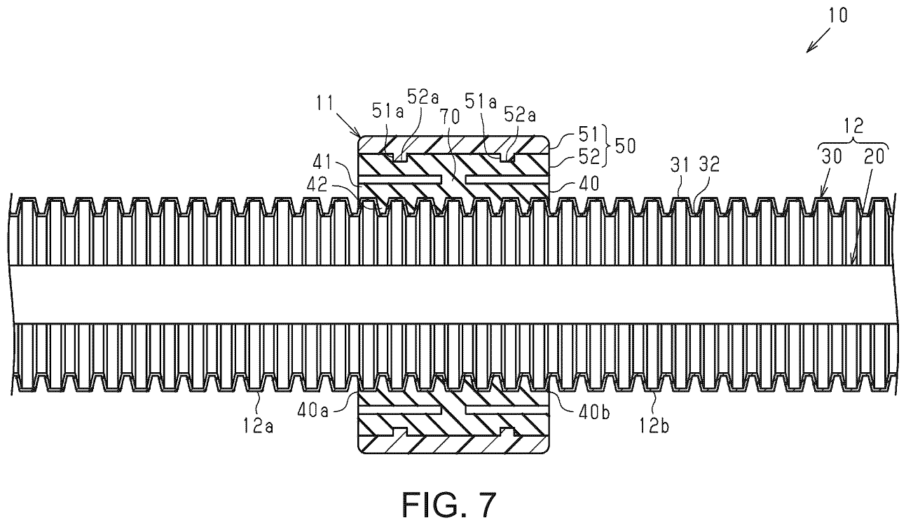

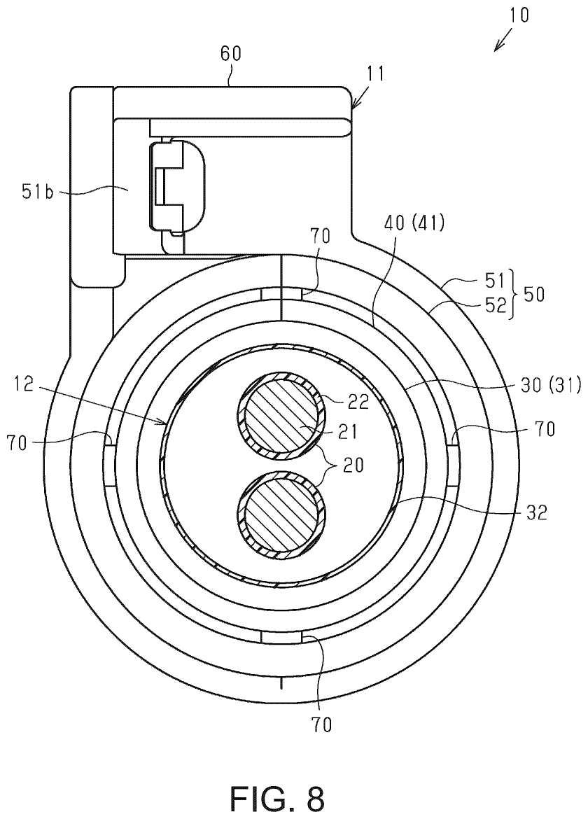

The present embodiment can be implemented with the following variations. The present embodiment and the following variations can be implemented in combination with each other as long as no technical contradiction arises.
As shown in FIG. 7, the position of the support member 70 of the clamp 11 may be changed to a central position between the first opening end 40a and the second opening end 40b of the first tubular member 40. Also, although not shown, the position of the support member 70 of the clamp 11 may be changed to an end position along the opening end of either the first opening end 40a or the second opening end 40b of the first tubular member 40.
The number of support members 70 of the clamp 11 is not limited to singular, and the support member 70 may be divided into a plurality of parts. For example, the support member 70 shown in FIG. 8 may be divided into a plurality of parts in the circumferential direction of the first tubular member 40. Although not shown, the support member 70 may be divided into multiple parts in the axial direction of the first tubular member 40.
The second outer circumferential wall 51 and the second inner circumferential wall 52 of the above clamp 11 are assembled in an engaged relationship, but a configuration is also possible in which the portions that engage each other are omitted and the clamp 11 is assembled using pressure contact between an inner circumferential surface of the second outer circumferential wall 51 and an outer circumferential surface of the second inner circumferential wall 52.
The first protruding portions 42 of the first tubular member 40 of the above clamp 11 may be omitted, and the wire member 12 may be held in the first tubular member 40 using pressure contact between an inner circumferential surface of the first tubular member 40 and an outer circumferential surface of the wire member 12.
The above clamp 11 can also be used to hold a wire member with the exterior member 30 of the wire member 12 omitted, that is, a coated wire.
The second tubular member 50 has the second outer circumferential wall 51 and the second inner circumferential wall 52, but the second tubular member 50 can also be formed by a single circumferential wall.
The first tubular member 40, the second tubular member 50, and the support member 70 can be made of the same material.
The axial dimension of the first tubular member 40 and the axial dimension of the second tubular member 50 may be the same or different. When the axial dimension of the second tubular member 50 is assumed to be 100, for example, the axial dimension of the first tubular member 40 is preferably 80 to 120, and more preferably 90 to 110.
The distance between the first tubular member 40 and the second tubular member 50 of the clamp 11 can be set by the dimensions of the support member 70. The distance between the first tubular member 40 and the second tubular member 50 can be set in accordance with the outer diameter of the wire member 12, for example. The distance between the first tubular member 40 and the second tubular member 50 is not particularly limited, but is, for example, 1 mm or more, 3 mm or more, or 5 mm or more. The distance between the first tubular member 40 and the second tubular member 50 is, for example, 100 mm or less.
The support member 70 of the illustrated embodiment may be referred to as one or more flexible bridges or flexible bridging spacers that radially bridge an outer circumferential surface of the first tubular member 40 and an inner circumferential surface of the second tubular member 50. The radial bridges or radial bridging spacers may be directly connected to a first predetermined position on the outer circumferential surface of the first tubular member 40 and a second predetermined position on the inner circumferential surface of the second tubular member 50. The support member 70 may be configured to allow a change in an relative angle between the axis of the first tubular member 40 and the axis of the second tubular member 50, and to substantially not allow relative rotation between the outer circumference of the first tubular member 40 and the inner circumference of the second tubular member 50, and to substantially not allow relative movement in the length direction between the outer circumference of the first tubular member 40 and the inner circumference of the second tubular member 50. The support member 70 may define an open space between the outer circumference of the first tubular member 40 and the inner circumference of the second tubular member 50 that allows relative displacement (change in the angle between the two axes) of the first tubular member 40 and the second tubular member 50. In the illustrated embodiment, the support member 70 itself performs flexural deformation in response to bending deformation of the wire member 12, thereby minimizing the amount of displacement of the second tubular member 50 that follows the bending deformation of the wire member 12, while ensuring the displacement amount of the first tubular member 40 that follows the bending deformation of the wire member 12.
It should be appreciated that the embodiments and variations disclosed herein are to be construed in all respects as illustrative and not limiting. The scope of the present disclosure is defined by the claims, rather than by the description preceding them, and is intended to include all modifications which fall within the scope of the claims and the meaning and scope of equivalents thereof.

1. A clamp comprising:
a first tube configured to hold wire;
a second tube disposed spaced apart from the first tube and covering an outer circumference of the first tube;
a fixing member provided on the second tube and configured to fix the second tube to a vehicle; and
a support provided between the first tube and the second tube, and supporting the first tube on the second tube,
wherein the support displaceably supports the first tube such that an axis of the first tube inclines with respect to an axis of the second tube.

2. The clamp according to claim 1, wherein:
the second tube has an outer circumferential wall and an inner circumferential wall disposed between the outer circumferential wall and the first tube,
the fixing member is connected to the outer circumferential wall,
the support is connected to the inner circumferential wall, and
the first tube, the support, and the inner circumferential wall are made of a material more elastically deformable than the outer circumferential wall and the fixing member.

3. The clamp according to claim 2, wherein:
the first tube, the support, and the inner circumferential wall are made of a rubber-based material, and
the outer circumferential wall and the fixing member are made of a resin-based material.

4. The clamp according to claim 3,
wherein the first tube, the support, and the inner circumferential wall are an integrally molded article made of a rubber-based material.

5. The clamp according to claim 2,
wherein the outer circumferential wall and the inner circumferential wall are assembled in an engaged relationship.

6. The clamp according to claim 1,
wherein the first tube has a first opening end and a second opening end that are opposite opening ends in an axial direction of the first tube, and the support is located on a center side relative to the first opening end and the second opening end.

7. The clamp according to claim 6,
wherein the support is disposed at a position closer to one of the first opening end and the second opening than the other of the first opening end and the second opening end.

8. The clamp according to claim 1,
wherein the support has an annular shape along a circumferential direction of the first tube and the second tube.

9. A wire harness comprising:
the clamp according to claim 1; and
the wire held by the first tube of the clamp.
